(19) United States
(12) Patent Application Publication
(10) Pub. No.: US 2016/0044136 A1
(43) Pub. Date: Feb. 11, 2016

(54) VIRTUAL GATEWAY

(71) Applicant: NIMBUS 9, INC., Colorado Springs, CO (US)

(72) Inventors: Lucas Schiff, Monument, CO (US); Andrew Hutchison, Colorado Springs, CO (US)

(21) Appl. No.: 14/721,581

(22) Filed: May 26, 2015

Related U.S. Application Data
(60) Provisional application No. 62/003,368, filed on May 27, 2014.

(51) Int. Cl. H04L 29/08; H04L 29/06; H04L 12/24; H04L 12/713

(52) U.S. Cl. CPC H04L 67/34; H04L 67/10; H04L 45/586; H04L 69/18; H04L 41/0813

(57) ABSTRACT

Systems, software, and methods are provided to create a virtual appliance that serves the purpose of connecting devices that are placed directly onto the Internet without the use of a hardware gateway. Code can be embedded into the device, which allows it to communicate to the cloud services and connect to its authorized virtual gateway, thereby eliminating the need for an intermediate hardware gateway.

### CROSS REFERENCE TO RELATED APPLICATIONS

This application claims priority to, and benefit from, provisional patent application Ser. No. 62/003,368, entitled “Virtual Gateway”, filed May 27, 2014, which is incorporated herein by reference for all purposes.

### BACKGROUND

Many systems allow for some control of devices using remote devices, the Internet, and the cloud. These systems are cumbersome and the user may need to know and use device specific information to control the devices.

### OVERVIEW

Systems, software, and methods are provided to create a virtual appliance that serves the purpose of connecting or grouping devices that are placed directly onto the Internet without the use of a hardware gateway. Code can be embedded into the device, which allows it to communicate to the cloud services and connect to its authorized virtual gateway, thereby eliminating the need for an intermediate hardware gateway.

### BRIEF DESCRIPTION OF THE DRAWINGS

FIG. 1 is a system diagram illustrating virtual gateway system, according to an example.

FIG. 2 illustrates a database configuration and function, according to an example.

FIG. 3 illustrates a cloud services configuration and function, according to an example.

FIG. 4 illustrates a virtual gateway configuration and function, according to an example.

FIG. 5 illustrates a device configuration and function, according to an example.

FIG. 6 illustrates a monitoring computing environment according to one example.

FIG. 7 illustrates a computing environment according to an example.

### DESCRIPTION

What has yet to be seen in the controls industry is a complete end to end solution that is centered on the cloud being the central intelligence. One of the hurdles that must be overcome is consolidating the vast amount of ways that devices can be connected to the Internet and supporting whichever protocols they are connected with in the last mile.

The purpose of this invention is to create a virtual appliance that serves the purpose of connecting devices that are placed directly onto the Internet without the use of a hardware gateway. Code is embedded into the device itself that allows it to “dial home” to the cloud services and connect to its authorized virtual gateway, thereby eliminating the need for an intermediate hardware gateway.

By creating a virtual gateway appliance, it is possible to connect direct devices that act just as a hardware gateway connected device and are interoperable with all existing services. To the end user, all of this is completely masked to keep the user experience contiguous. This is meant to include anything that might be part of automating a building or home, but does not exclude other applications such as: industrial, agriculture, transportation and logistics, energy and utilities, healthcare, government and public services.

Systems, methods, and software are provided to create a virtual appliance that serves the purpose of connecting devices that are placed directly onto the Internet without the use of a hardware gateway. Code is embedded into the device itself that allows it to “dial home” to the cloud services and connect to its authorized virtual gateway, thereby eliminating the need for an intermediate hardware gateway.

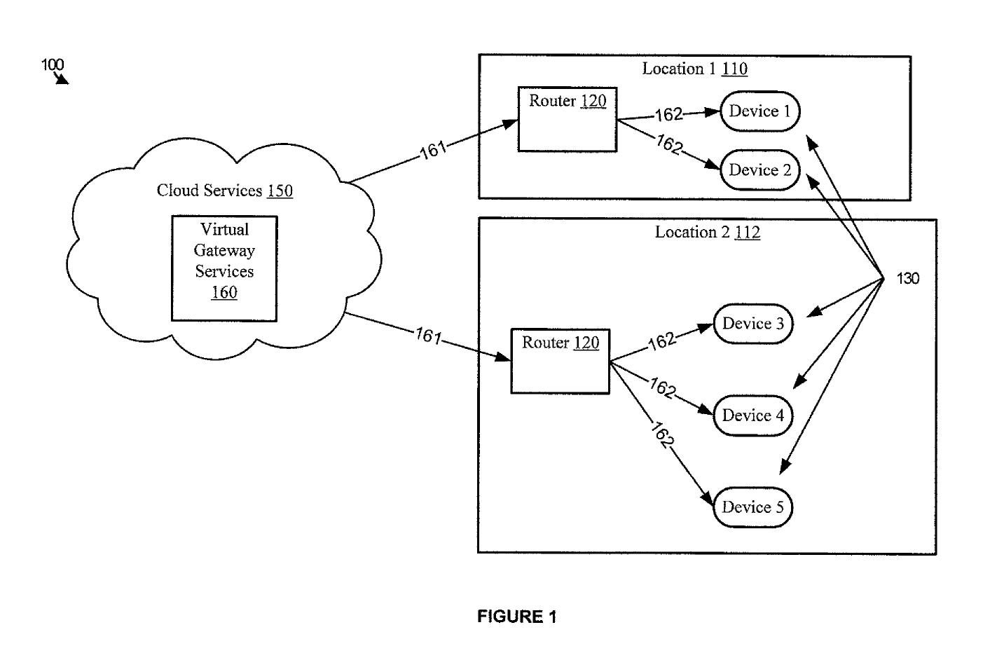

FIG. 1 is a system diagram illustrating virtual gateway service system 100, according to an example. System 100 includes cloud services 150, locations 110 112, router 120, device 130. Device 130 communicates over link 162 to router 120. Router 120 communicates over link 161 to Cloud Services 150.

Cloud services 150 is shown as a generic cloud, with multiple underlying services and technologies which comprise a singular service to an end user. Cloud services 150 refers to anything which is part of a service that is hosted remotely and accessible from anywhere via the Internet or other communication network or system. Cloud services 150 may include computing systems, servers, software, and other devices and systems.

Cloud services 150 act as a central resource for communicating with devices 130. Cloud services provide centralized messaging, computing, data storage, analytics, user management, device 130 management, gateway management (physical and virtual), account management, location 110 112 management, control messaging, asynchronous state messaging and displayed information. Cloud services 150 acts as a resource that sends and receives data from virtual gateway services and consolidates all data to provide a singular list of devices based on location 110 112, regardless of how the devices are connected.

Router 120 may include an Internet router and/or any router that can take network traffic (i.e. TCP/IP or UDP) from a network and provides access to another network, such as the Internet. Router 120 connects to cloud services 150 through link 161.

Device 130 is any electronic device which has a way to communication via any communication medium (i.e. wireless radio, power-line communication, etc.) and device messaging protocol. Examples of device 130 may include, but not limited to: light bulbs, lighting drivers, wireless adapters, photo sensors, motion sensors, water/moisture sensors, position sensors, magnetic sensors, switches, temperature sensors, fluid level sensors, thermostats, network sensors, power outlets, circuit breakers, utility meters, display devices, appliances (washer, dryer, refrigerator, dishwasher, audio/visual equipment, toaster, microwave, oven, stove, coffee maker, etc. . . . ), cameras, computers, mobile devices, GPS, locking devices, proximity sensors, security card/badge readers, intrusion sensors, battery sensor, etc.

Device(s) 130 communicate to cloud services 150 via link 162 through Router 120. Device 130 may be sent messages from cloud services 150 to control it and also may send messages to cloud services 150 for the purpose of communicating state, status, power consumption, and other information about the device 130 or area adjacent device 130, or other information, etc.

Location(s) 110 112 may include any physical site that one or more device 130 components physically reside. Examples include, but are not limited to: commercial buildings, residential homes, industrial buildings, hospitals, hotels, motels, multiple dwelling units, agricultural facilities, etc.

Link 161 uses various communication media, such as air, space, metal, optical fiber, or some other signal propagation path, including combinations thereof. Link 161 could use various communication protocols, such as Internet Protocol (IP), Ethernet, Wireless Fidelity (Wi-Fi), Time Division Multiplexing (TDM), Asynchronous Transfer Mode (ATM), Code Division Multiple Access (CDMA), Evolution-Data Optimized (EV-DO), single-carrier radio transmission technology, Frame relay, optical, synchronous optical networking (SONET), or some other communication format, including combinations, improvements, or variations thereof. Link 161 could be a direct link or may include intermediate networks, systems, or devices.

Link 162 may carry the communication that stems from device 130 and may connect to router 120 or directly to cloud services 150. Link 162 uses various communication media, such as air, space, metal, optical fiber or some other signal propagation path, including combinations thereof. Link 162 could use various communications protocols, such as Internet Protocol (IP), Ethernet, Wireless Fidelity (Wi-Fi), 6LowPAN, TCP/IP, or some other communication format, including combinations, improvements, or variations thereof. Link 162 could be a direct link or may include intermediate networks, systems, or devices.

Devices 130 may communicate information to cloud services 150, such as configuration information for the device 130. Furthermore, cloud services 150 may receive virtual gateway configuration information from a user and/or user device. Cloud services 150 may display available devices 130 to the user such that the user may associate one or more devices 130 with a newly created virtual gateway in a relational or other database.

Once created the virtual gateway may be displayed to the user via a user interface. The user may then be presented with various controls, such as on or off, for the virtual gateway. If the user turns the virtual gateway to off, all devices associated with the virtual gateway may be turned off The user may provide the input for controlling the virtual gateway, which then may be translated to information to control the associated devices.

With this system the cost of a hardware gateway may be eliminated. Furthermore, the time and frustration with connecting devices to a hardware gateway, as well as configuring the hardware gateway are reduced or eliminated. Yet further, a user may use a relatively user-friendly interface to control various devices without knowing much or any information about the devices, or control protocols or instructions, etc.

The user may also be presented with other information about the devices associated with the virtual gateway, such as state, communication state, power consumption, and/or other information.

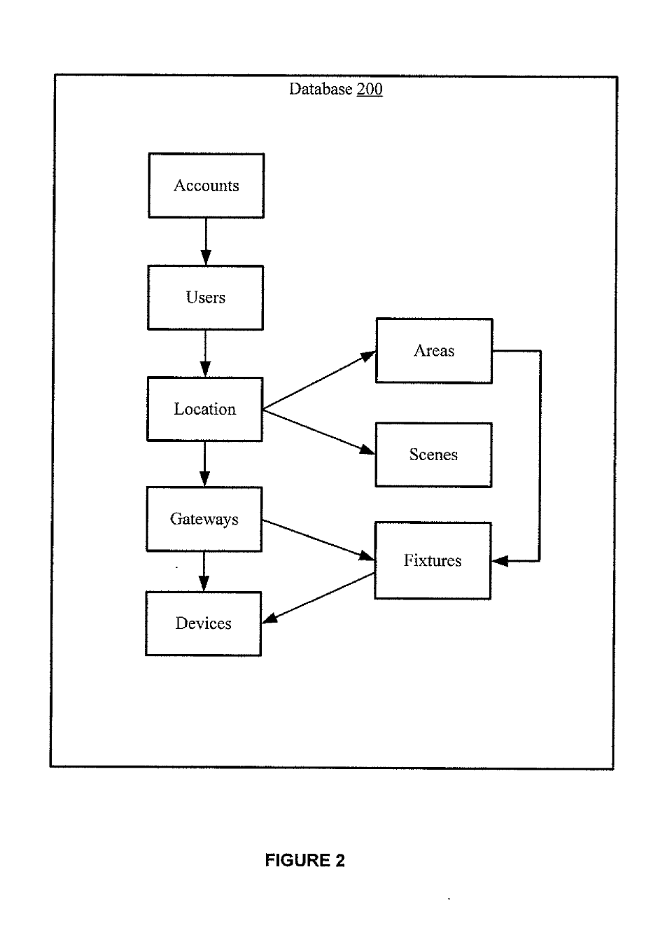

FIG. 2 describes the contents of a database 200, according to an example. Database 220 may be a part of cloud services 150, or may be separate.

In an example, database 200 consists of multiple collections of data. These collections are defined as Accounts, Users, Locations, Gateways, Devices, Areas, Scenes and Fixtures. Accounts represent the highest level in an example data hierarchy. All collections or data grouping may be included under a specific account, which helps define access to overall data for an account. Users represent individual user accounts that are part of the overall account. Locations represent the physical sites that fall under an account.

An account can have a limitless amount of locations associated with it. Gateways represent the physical Gateway devices and virtual gateway services that fall under a specific location. Devices represent the devices 130 that are connected to the Gateways (physical and virtual) and fall under the gateways collection. Fixtures represent a collection of one or more devices and fall under gateways.

Areas represent a collection of one or more fixtures and fall under locations. By doing so, an area is able to have fixtures from any gateway, without regard to physical connection. Scenes represent a collection of one or more fixtures and can store a specific set point and fall under locations. By doing so, a scene is able to have fixtures, with specific set points from any gateway, without regard to physical connection.

All of this information and virtual gateway information may be stored in a relational and/or other database 200.

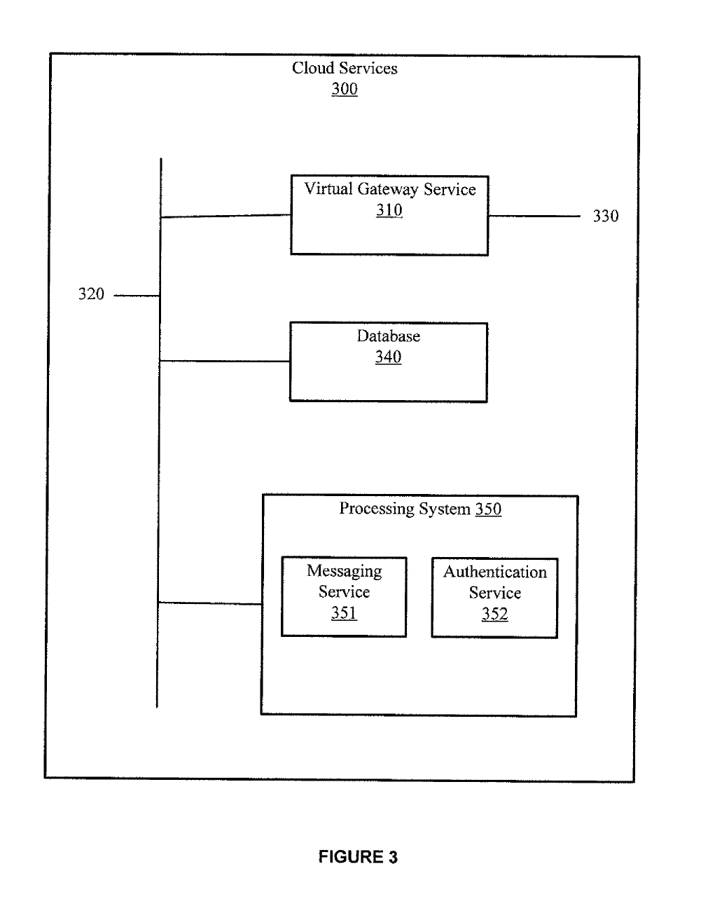

FIG. 3 describes example Cloud Services 300. Cloud Services 300 consists of several components, including Virtual Gateway Services 310, Internal Network 320, External Network 330, Database 340 and Processing System 350 which consists of Messaging Service 351 and Authentication Service 352. Virtual Gateway Service 310 communicates over link External Network 330 from direct Internet connected devices or devices connected through a router o other devices. Virtual gateway service 310 then communicates over link Internal Network 320 to Database 340 and Processing System 350.

Virtual Gateway Services 310 may include a system that connects external, direct Internet connected devices (such as a Wi-Fi thermostat) to Cloud Services 150 and assigns them appropriately to the cloud database 200 just as if it had connected through an actual physical gateway for association with an account or user. By doing this, the need for a physical gateway may be eliminated or reduced, and the device will be capable of communicating with its appropriate virtual gateway, user, and/or account.

Messaging service 351 may include an internal cloud system that processes incoming messages and outgoing messages and information from the devices and the user device or input. All communication between devices, the cloud services, user, and the client application can be routed through the messaging service 351.

In an example, authentication Service 352 may include an OAuth2.0 based authentication program that authenticates the validity of a message being passed between client application, cloud services, and devices. It used a token system which, once a user has successfully logged into their account, will use an encryption token to then begin communication without the need for sending the user and password. It validates that a message is from the true owner and is validated as authentic.

The devices may be capable of communicating via a network. Cloud services 300 may also be able to connect to the same, similar, and/or connected network. The user may define virtual gateways, which the devices are defined to connect through. Physical gateways may also be used, and the devices may connect in this manner as well.

The user may then control and manipulate the devices at least in part using the cloud services via a user device. The virtual gateways may be used to group or organize the various devices, such that the user may more easily manage the system of device controls.

The devices may be grouped by device type(s), location(s), floor(s), room(s), other logical grouping, and/or any other grouping, and/or combinations thereof.

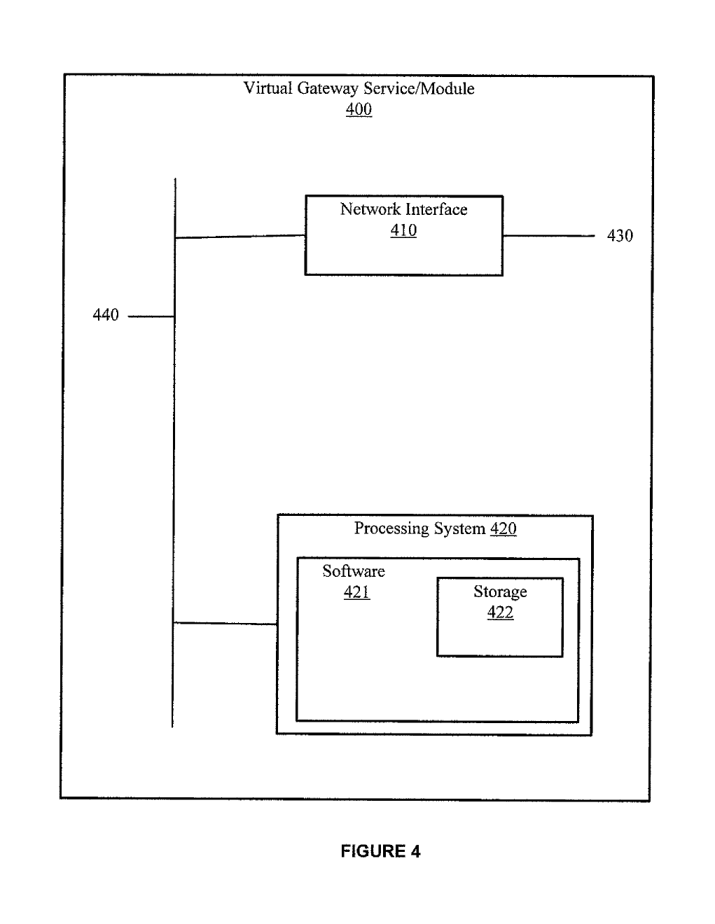

FIG. 4 describes an example Virtual Gateway Service 400. Virtual Gateway Service 400 consists of several components, including Network Interface 410, Processing System 420 (which includes Software 421 and Storage 422), External Network 430 and Internal Service Bus 440.

Network Interface 410 communicates over link External Network 430 with direct Internet connected devices and with internal services over link Internal Service Bus 440 to Processing System 420. This system provides connection services to external, direct Internet connected devices or other services, and translates their messaging structure into internal Cloud Service messaging for use by end users.

Virtual gateway service 400 may include hardware, software and/or firmware capable of defining a virtual gateway for use in controlling remote devices.

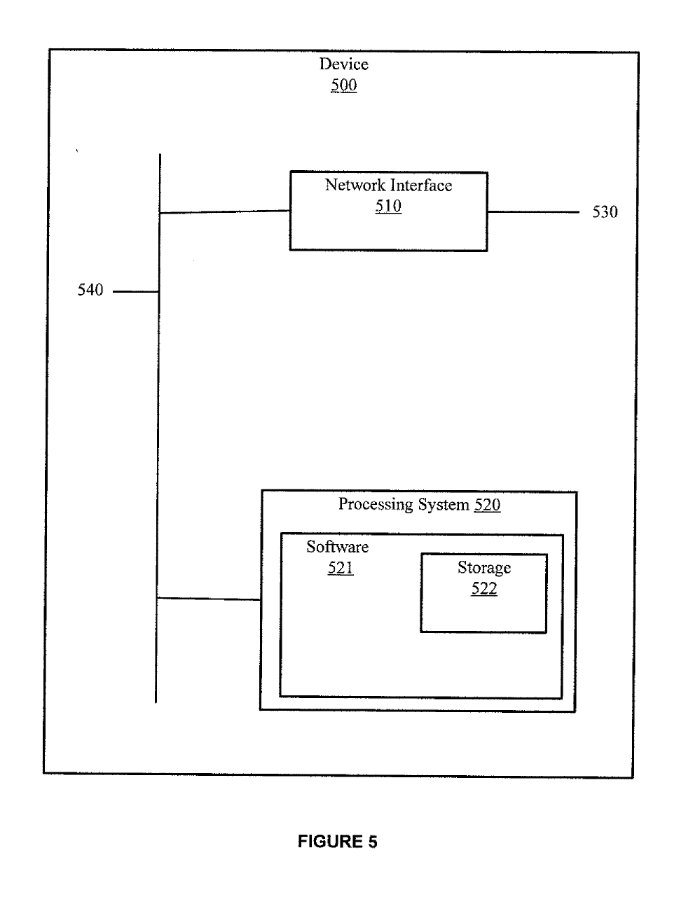

FIG. 5 describes an example device 500. Device 500 consists of Network Interface 510, Processing System 520 (which includes Software 521 and Storage 522), External Network 530 and Internal Service Bus 540. Network Interface 510 communicates with Processing System 520 over link Internal Service Bus 540 and communicates externally to Router 120 or via direct Internet connection or other connection over link External Network 530.

A virtual gateway may be created. The creation may include a name for the gateway as well as information about the devices associated with the gateway and other information about the gateway. Devices may then be associated with the created virtual gateway. This may include logically connecting the devices to the virtual gateway.

The user may then send control information and instructions to the virtual gateway, which may be translated to another protocol to control the associated devices. The associated devices may then send information to the virtual gateway, and that information may be presented as a function of the virtual gateway. The information sent from the devices to the virtual gateway may be translated from a device protocol to another protocol to be used by the cloud services, and/or the virtual gateway.

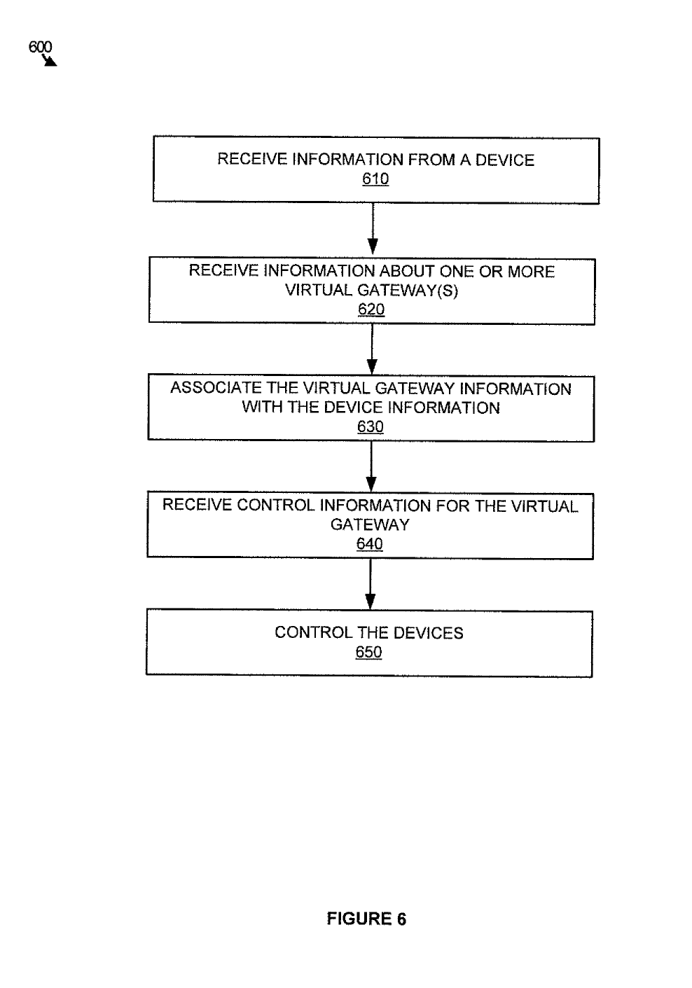

FIG. 6 is a method 600 of controlling devices at least in part with a virtual gateway, according to an example. Method 600 includes receiving information from one or more devices 610. Devices may be able to connect to a network and then to the Internet. The devices may send configuration information that may be used by cloud services to set up communication and control of the devices.

Method 600 also includes receiving information about one or more virtual gateways 620, which may define a particular virtual gateway. A user may input this information, and/or the information may be predetermined and predefined. Some devices may be associated with the defined or created virtual gateway 630. The devices which have communicated with the system may be shown such that a user may select the device to be associated with a virtual gateway.

The information from the devices may be received by a virtual gateway, and translated. This may be based at least in part on the information about the virtual gateway(s). The device information may also not be translated, and grouped or displayed as a function of the virtual gateways.

Control information may be received 640 for the virtual gateway and/or devices. This may be inputted by a user or may be automatic or preprogrammed. This may include controlling devices, such as lights, on a timed schedule.

The control information may then be sent 650 to the virtual gateway and/or devices to control the devices. The devices may change state, programming, or otherwise carry out the control information. The devices may then periodically or when polled, send information about the device, such as state, communication state, power consumption, temperature, images, motion detection, etc.

Although the example method controls devices via a virtual gateway, it should be understood that the method could apply to any situation that controls devices.

Additionally, it should be understood that the order of events in method 600 could be rearranged or accomplished concurrently by various different devices, etc.

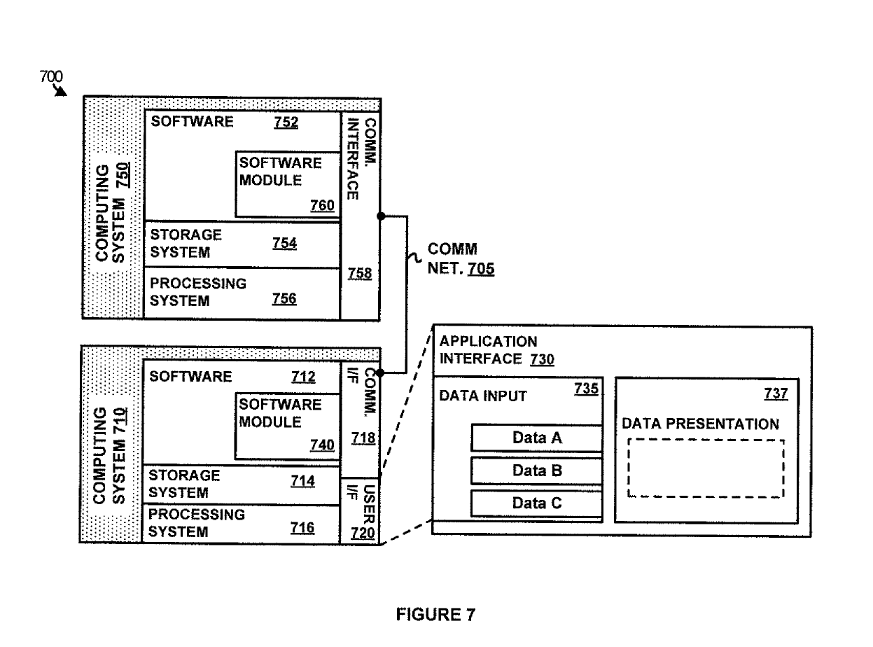

FIG. 7 illustrates a monitoring computing environment 700 according to one example. Computing environment 700 includes computing system 710 and computing system 750. Computing system 710, in the present example, corresponds to user device, and computing system 750 corresponds to cloud services 150. Computing system 710 can include any smart phone, tablet computer, laptop computer, or other computing or mobile device capable of reading, and/or recording data about systems, devices, locations, and/or equipment, etc. Computing system 750 can include any server computer, desktop computer, laptop computer, or other device capable of storing and managing the data received from computing system 710 and database 200 and/or 340, as well as modules for controlling devices, as described herein.

In FIG. 7, computing system 710 includes processing system 716, storage system 714, software 712, communication interface 718, and user interface 720. Processing system 716 loads and executes software 712 from storage system 714, including software module 740. When executed by computing system 710, software module 740 directs processing system 716 to receive data systems, devices, locations, and/or equipment, etc. Such data could include any of the information described above, including but not limited to the hardware, software, firmware, and functionality described for FIGS. 1-6.

Although computing system 710 includes one software module in the present example, it should be understood that one or more modules could provide the same operation. Similarly, the computing systems may be distributed using other computing systems and software.

Additionally, computing system 710 includes communication interface 718 that can be further configured to transmit the user inputs and data to computing system 750 using communication network 705. Communication network 705 could include the Internet, cellular network, satellite network, RF communication, blue-tooth type communication, near field, or any other form of communication network capable of facilitating communication between computing systems 710, 750. This includes systems described above for links 161 and 162.

Referring still to FIG. 7, processing system 716 can comprise a microprocessor and other circuitry that retrieves and executes software 712 from storage system 714. Processing system 716 can be implemented within a single processing device but can also be distributed across multiple processing devices or sub-systems that cooperate in executing program instructions. Examples of processing system 716 include general purpose central processing units, application specific processors, and logic devices, as well as any other type of processing device, combinations of processing devices, or variations thereof.

Storage system 714 can comprise any storage media readable by processing system 716, and capable of storing software 712. Storage system 714 can include volatile and nonvolatile, removable and non-removable media implemented in any method or technology for storage of information, such as computer readable instructions, data structures, program modules, or other data. Storage system 714 can be implemented as a single storage device but may also be implemented across multiple storage devices or sub-systems. Storage system 714 can comprise additional elements, such as a controller, capable of communicating with processing system 716.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

Although one software module is shown, the software may be distributed across many devices, storage media, etc.

User interface 720 can include a mouse, a keyboard, a camera, image capture, a Barcode scanner, a QR scanner, a voice input device, a touch input device for receiving a gesture from a user, a motion input device for detecting non-touch gestures and other motions by a user, and other comparable input devices and associated processing elements capable of receiving user input from a user. These input devices can be used for defining and receiving data about the devices, gateways, systems, devices, locations, and/or equipment, etc. Output devices such as a graphical display, speakers, printer, haptic devices, and other types of output devices may also be included in user interface 720. The aforementioned user input and output devices are well known in the art and need not be discussed at length here.

Application interface 730 can include data input 735 and data presentation 737. In one example, data input 735 can be used to collect information regarding a devices, locations, etc. to be controlled.

Further, application interface 730 could include data presentation portion 737, which could be used to present information about gateways, systems, devices, locations, and/or equipment, etc. It should be understood that although computing system 710 is shown as one system, the system can comprise one or more systems to collect data.

In an example, computing system 750 includes processing system 756, storage system 754, software 752, and communication interface 758. Processing system 756 loads and executes software 752 from storage system 754, including software module 760. When executed by computing system 750, software module 760 directs processing system 710 to store and manage the data from computing system 710, devices, virtual gateways, and other computing systems. The data can include information about gateways, devices, locations, etc., as well as one or more software module to control, configure, manipulate devices, etc.

Although computing system 750 is shown as including one software module in the present example, it should be understood that one or more modules could provide the same operation.

Additionally, computing system 750 includes communication interface 758 that can be configured to receive the data from computing system 710 using communication network 705.

Referring still to FIG. 7, processing system 756 can comprise a microprocessor and other circuitry that retrieves and executes software 752 from storage system 754. Processing system 756 can be implemented within a single processing device but can also be distributed across multiple processing devices or sub-systems that cooperate in executing program instructions. Examples of processing system 756 include general purpose central processing units, application specific processors, and logic devices, as well as any other type of processing device, combinations of processing devices, or variations thereof.

Storage system 754 can comprise any storage media readable by processing system 756, and capable of storing software 752 and data from computing system 710. Data from computing system 710 may be stored in a database or any other form of digital file. Storage system 754 can include volatile and nonvolatile, removable and non-removable media implemented in any method or technology for storage of information, such as computer readable instructions, data structures, program modules, or other data. Storage system 754 can be implemented as a single storage device but may also be implemented across multiple storage devices or sub-systems. Storage system 754 can comprise additional elements, such as a controller, capable of communicating with processing system 756.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

Software 760 may include portions or all of databases 200 340, cloud services 300, virtual gateway service 400, as well as other functionality.

In some examples, computing system 750 could include a user interface The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user. This configuration may eliminate the need to receive information from a user device.

Output devices such as a graphical display, speakers, printer, haptic devices, and other types of output devices may also be included in the user interface. The aforementioned user input and output devices are well known in the art and need not be discussed at length here.

It should be understood that although computing system 750 is shown as one system, the system can comprise one or more systems to store and manage received data.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for controlling and receiving information from remote devices using a cloud infrastructure, comprising;
receiving virtual gateway configuration information for devices to be controlled from a user device at a computing device;
receiving device configuration information from a device to be controlled at the computing device;
associating the virtual gateway configuration information with the device configuration information in a database;
receiving virtual gateway control inputs from the user device; and
controlling the device to be controlled based at least in part on the received virtual gateway control inputs.

2. The method of claim 1, wherein the computing device comprises cloud services.

3. The method of claim 1, wherein the virtual gateway control inputs received in a first communication protocol and are translated from the first communication protocol to a second communication protocol by the computing device, wherein the second communication protocol is used to communicate to the device to be controlled.

4. The method of claim 1, wherein the controlling is based at least in part using the associated information from the database.

5. The method of claim 1, wherein the device to be controlled comprises a light emitting device.

6. The method of claim 1, further comprising presenting virtual gateway control information to the user at least in part via a user interface of the user device, and wherein the virtual gateway control inputs are received from the user interface.

7. The method of claim 1, wherein one or more devices to be controlled are associated with a virtual gateway, and wherein the virtual gateway control information is received from a user device and translated to instructions used to control the one or more associated devices to be controlled.

8. A non-volatile commuter readable medium, having stored thereon instructions, which if executed by a processor, cause the processor to:
receive device configuration information and virtual gateway configuration information for devices to be controlled from a user device and from devices to be controlled at a computing device;
present the device configuration or virtual gateway configuration information based at least in part on the device configuration information or virtual gateway information;
receive virtual gateway control information from a user; and
control the devices to be controlled based at least in part on the received virtual gateway control information,
wherein the virtual gateway control information is received in a first communication protocol and translated to a second communication protocol;
wherein the second communication protocol is used to control the devices to be controlled.

9. The computer readable medium of claim 8, having further instructions, wherein the computing device comprises cloud services.

10. The computer readable medium of claim 8, having further instructions, wherein the virtual gateway is configured to translate information to and from the devices to be controlled in the first protocol to the second protocol used by the computing device.

11. The computer readable medium of claim 8, having further instructions, wherein one or more devices to be controlled are associated with a virtual gateway, and wherein the virtual gateway control information is received from a user device and translated to instructions used to control the one or more associated devices to be controlled.

12. The computer readable medium of claim 8, having further instructions, wherein the device configuration and the virtual gateway configuration are related together into relational information a database.

13. The computer readable medium of claim 8, having further instructions, wherein the control of the devices to be controlled is accomplished at least in part on the relational information.

14. The computer readable medium of claim 8, having further instructions

[symbol]

15. A system for controlling and receiving information from devices, comprising:
a device capable of sending an receiving information;
a computing system capable of receiving device configuration from the device, and receiving virtual gateway configuration information from a user device,
wherein the virtual gateway configuration information comprises a created virtual gateway, and associating one or more devices with the created virtual gateway in a database;
wherein the computing system is further configured to receive virtual gateway control inputs from the user device, and control the devices associated with the created virtual gateway based at least in part of the received virtual gateway control inputs.

16. The system of claim 15, further comprising a router configured to receive information from the computing system in a first communication protocol, and translate the received information to a second communication protocol, and send the received information in the second communication protocol to one or more of the devices.

17. The system of claim 15, wherein the router is configured to receive device information from one or more of the devices in the second communication protocol, and translate the received device information to the first communication protocol, and send the received device information in the second communication protocol to the computing system.

18. The system of claim 15, wherein the computing system comprises cloud-based services.

19. The system of claim 15, wherein the device comprises a light emitting device.

20. The system of claim 15, wherein the computing system is further configured to present a representation of the created virtual gateway at least in part via a user interface, and receive the virtual gateway control information at least in part via the user interface, and translate the received virtual gateway control information to instructions used to control one or more of the devices.
